(19) United States
(12) Patent Application Publication
(10) Pub. No.: US 2004/0067664 A1
(43) Pub. Date: Apr. 8, 2004

(54) Circuit terminal adapter

(76) Inventors: Andrew Proudfoot, Kirkland (CA); Ravinder Bilkhu, Pierrefonds (CA); Michael Copley, Chateauguay (CA)

Correspondence Address: Ronald S. Kosie, BROUILLETTE KOSIE PRINCE, 25th Floor, 1100 Rene-Levesque Boulevard West, Montreal, QC, H3B 5C9, CA

(21) Appl. No.: 10/342,417

(22) Filed: Jan. 15, 2003

(30) Foreign Application Priority Data
Oct. 8, 2002 (CA) 2,406,825

(51) Int. Cl. H01R 12/00

(52) U.S. Cl. 439/68

(57) ABSTRACT

A circuit assembly comprising:

a circuit associated with a support substrate; and

a connection terminal disposed on said support substrate for electrically connecting said circuit assembly to an other device;

characterized in that said circuit assembly comprises a terminal adapter,

said terminal adapter comprising a conductive member,

said conductive member comprising a first connection element, a second connection element, and an intermediate connection element, said intermediate connection element electrically connecting said first connection element to said second connection element,

said terminal adapter being disposed such that

said second connection element is fixed and electrically connected to said connection terminal, and

said first connection element is disposed for electrical connection to said other device. The circuit assembly may be used to facilitate incorporation of electronic components into a larger assembly.

### BACKGROUND OF THE INVENTION

The present invention relates to the field of electronic components. The invention in particular relates to the improvement of connection terminals. In particular the improvement of miniaturized connection terminals.

It should be noted that while the present invention is described in relation to miniaturized connection terminals, it may be used with connection terminals of any size.

As electronic devices become more complex there is also a need, in may cases, to make these devices smaller. The drive to miniaturize electronic devices requires that new methods be employed to ensure that reliable and practical use of these devices can be made. Many electronic devices need to be small for applications such as hearing aids, endoscopes, and sensor components.

The most common method of connecting different components to form an electronic device is through the use of a substrate that supports the components. The support substrate may have one or more non-conductive layers. Sandwiched between the non-conductive layers are conductive traces, which provide electrical interconnection between components that are electrically attached to the substrate.

The electronic components are usually attached to connection terminals on the substrate. Connection terminals are also used to electrically connect the device to other devices. These connection terminals are usually made from various metals and are attached to the substrate along with the conductive traces.

The connection terminals have also needed to be made smaller as devices have been miniaturized. Unfortunately, making the terminals smaller also made them more susceptible to damage due to the heating involved in making soldered joints (i.e. through leaching) and from the fact that a smaller terminal has a smaller resistance to pulling forces.

As stated above connection terminals are used to connect one electronic device to another. To form the connections flexible leads, such as wires, are usually attached to the connection terminals through the process of soldering. Soldering is a process whereby a molten conductive material called solder, most commonly made from a lead and tin alloy, is applied to the surface of the connection terminals. Subsequently a wire, is placed in the conductive material, which is then allowed to cool and harden, thus forming a mechanical and electrical connection between the wire and the connection terminal.

While the process of soldering is a good way of creating strong connections, it may cause some problems, especially with repeated soldering and with smaller connection terminals. Due to the heat of the soldering process, it becomes possible for the metal of the connection terminal to melt and mix with the solder; i.e. in the case if the terminal is of a metal which is susceptible to melt at the solder temperature being used. This occurrence is called leaching since the metal of the connection terminal is said to leach into the solder.

As leaching progresses either by too much heat being applied during soldering or by repeated soldering, more and more metal is leached off from the connection terminal. If the leaching goes on for too long then the connection terminal will start to disappear, and the connection between the wire and the connection terminal will weaken. In the worst case, leaching can cause the connection terminal to disappear with no chance of repair. The problem of leaching is especially dangerous with small connection terminals since it takes a lot less leaching before the problem becomes serious.

The other major problem with smaller connection terminals comes from the pull forces exerted on the connection terminal from the attached flexible leads (wires).

To ensure that the connection between the wires and the connection terminals hold it is preferred that the connection be able to withstand a certain amount of pulling on the wire. The connection of the wire and the connection terminal has two important points which both need to be able to withstand the pulling force. These points are the attachment of the wire to the connection terminal, and the attachment of the connection terminal to the substrate. It is preferred that the adhesion of the wires to the connection terminals be able to withstand a pulling force of at least 0.8 lbf (3.56 N) on the wires.

Most connection terminals created using standard methods are unfortunately not able to withstand a force of 0.8 lbf. This is especially true for the smaller connection terminals used with the smaller electronic devices. The most common mode of failure being that the connection terminal is torn from the surface of the device with no chance of repair. Other modes of failure include the wire being torn from the solder and the solder detaching from the connection terminal.

In the past efforts have been made to solve the problems of reducing leaching and ensuring proper adhesion of wires to the connection terminals. Initial attempts have tried to make use of metals, which are not prone to leaching. These attempts have largely been unsuccessful since metals that have high resistance to leaching very often provide very poor adhesive qualities.

Other methods have been attempted, for instance in U.S. Pat. No. 5,928,568 to Paszkiet, et al., it is suggested that leaching can be reduced by providing a protective coating on the connection terminals. While this method does provide some protection against leaching it does not improve the adhesive qualities of the connection terminals.

Thus, it can be seen that there is a need for a new way of making circuit assemblies, which will make connection terminals less susceptible to leaching, as well as favor good adhesion.

### STATEMENT OF INVENTION

Therefore the present invention in one aspect provides a method for the manufacture of a circuit assembly connected to a flexible lead for connecting to an other device, said circuit assembly may comprise a circuit associated with a respective support substrate and a connection terminal disposed on said substrate for electrically connecting said circuit to an other device by said flexible lead, said method may comprise:

attaching to at least one of said circuit assemblies a terminal adapter comprising (and/or consisting of) a conductive member,

said conductive member comprising a first connection element, a second connection element, and an intermediate connection element, said intermediate connection element electrically connecting said first connection element to said second connection element,

said terminal adapter being disposed such that

said second connection element is fixed and electrically connected to said connection terminal, and

said first connection element is disposed for electrical connection to said flexible lead.

The invention in another aspect provides a circuit assembly that may comprise:

a circuit associated with a support substrate; and

a connection terminal disposed on said support substrate for electrically connecting said circuit assembly to an other device;

characterized in that said circuit assembly comprises a terminal adapter,

said terminal adapter comprising (and/or consisting of) a conductive member, said conductive member comprising a first connection element, a second connection element, and an intermediate connection element, said intermediate connection element electrically connecting said first connection element to said second connection element,

said terminal adapter being disposed such that

said second connection element is fixed and electrically connected to said connection terminal, and

said first connection element is disposed for electrical connection to said other device.

The invention in a further aspect provides a method for the manufacture of a circuit assembly connected to a flexible lead for connecting to an other device, said circuit assembly may comprise a circuit associated with a respective support substrate and a connection terminal disposed on (i.e. associated with) said substrate for electrically connecting said circuit to an other device by said flexible lead, said method may be characterized in that said circuit assembly comprises a terminal adapter wherein said terminal adapter comprises (and/or consists of) a conductive member,

said conductive member comprising a first connection element, a second connection element, and an intermediate connection element, said intermediate connection element electrically connecting said first connection element to said second connection element,

said terminal adapter being disposed such that

said second connection element is fixed and electrically connected to said connection terminal, and

said first connection element is disposed for electrical connection to said flexible lead

and wherein said method comprises soldering said flexible lead to said first connection element such that said flexible lead is fixed and electrically connected to said first connection element.

The invention in a further aspect provides a circuit assembly that may comprise:

a circuit associated with a support substrate;

a flexible lead for electrically connecting the circuit to an other device; and

a connection terminal disposed on said support substrate for electrically connecting said circuit to said flexible lead;

characterized in that said circuit assembly comprises a terminal adapter,

said terminal adapter comprising (and/or consisting of) a conductive member,

said conductive member comprising a first connection element, a second connection element, and an intermediate connection element, said intermediate connection element electrically connecting said first connection element to said second connection element,

said terminal adapter being disposed such that

said second connection element is fixed and electrically connected to said connection terminal, and

said first connection element is soldered to said flexible lead such that said flexible lead is fixed and electrically connected to said first connection element for electrical connection to said other device.

The invention in a further aspect provides a method for the manufacture of a circuit assembly connected to a flexible lead for connecting to an other device, said circuit assembly may comprise a circuit associated with a respective support substrate and a connection terminal disposed on said substrate for electrically connecting said circuit to an other device by said flexible lead, said method may comprise:

attaching to at least one of said circuit assemblies a terminal adapter comprising a conductive member and a non-conductive member,

said conductive member comprising a first connection element, a second connection element, and an intermediate connection element, said intermediate connection element electrically connecting said first connection element to said second connection element,

said non-conductive member extending from said first connection element to a second connection element

said terminal adapter being disposed such that

said second connection element is fixed and electrically connected to said connection terminal, and

said first connection element is disposed for electrical connection to said flexible lead.

The invention in a further aspect provides a circuit assembly that may comprise:

a circuit associated with a support substrate; and

a connection terminal disposed on said support substrate for electrically connecting said circuit assembly to an other device;

characterized in that said circuit assembly comprises a terminal adapter said terminal adapter comprising a conductive member and a non-conductive member;

said conductive member comprising a first connection element, a second connection element, and an intermediate connection element, said intermediate connection element electrically connecting said first connection element to said second connection element;

said non-conductive member extending from said first connection element to a second connection element;

said terminal adapter being disposed such that

said second connection element is fixed and electrically connected to said connection terminal, and

said first connection element is disposed for electrical connection to said other device.

The invention in a further aspect provides a method for the manufacture of a circuit assembly connected to a flexible lead for connecting to an other device, said circuit assembly may comprise a circuit associated with a respective support substrate and a connection terminal disposed on (i.e. associated with) said substrate for electrically connecting said circuit to an other device by said flexible lead, said method may be characterized in that said circuit assembly may comprise a terminal adapter wherein said terminal adapter comprises a conductive member and a non-conductive member,

said conductive member comprising a first connection element, a second connection element, and an intermediate connection element, said intermediate connection element electrically connecting said first connection element to said second connection element,

said non-conductive member extending from said first connection element to a second connection element

said terminal adapter being disposed such that

said second connection element is fixed and electrically connected to said connection terminal, and

said first connection element is disposed for electrical connection to said flexible lead

and wherein said method comprises soldering said flexible lead to said first connection element such that said flexible lead is fixed and electrically connected to said first connection element.

The invention in a further aspect provides a circuit assembly that may comprise:

a circuit associated with a support substrate;

a flexible lead for electrically connecting the circuit to an other device; and

a connection terminal disposed on said support substrate for electrically connecting said circuit to said flexible lead;

characterized in that said circuit assembly comprises a terminal adapter,

said terminal adapter comprising (and/or consisting of) a conductive member and a non-conductive member,

said conductive member comprising a first connection element, a second connection element, and an intermediate connection element, said intermediate connection element electrically connecting said first connection element to said second connection element,

said non-conductive member extending from said first connection element to said second connection element;

said terminal adapter being disposed such that

said second connection element is fixed and electrically connected to said connection terminal, and

said first connection element is soldered to said flexible lead such that said flexible lead is fixed and electrically connected to said first connection element for electrical connection to said other device.

The invention in a further aspect provides a circuit assembly that may comprise:

a plurality of circuits each associated with a corresponding support substrate; and

a plurality connection terminal disposed on said support substrates for electrically connecting said circuits to each other by a flexible lead;

characterized in that at least one said circuits comprises a terminal adapter,

said terminal adapter comprising a conductive member and a non-conductive member;

said conductive member comprising a first connection element, a second connection element, and an intermediate connection element, said intermediate connection element electrically connecting said first connection element to said second connection element;

said non-conductive member extending from said first connection element to a second connection element;

said terminal adapter being disposed such that

said second connection element is fixed and electrically connected to said connection terminal, and

said first connection element is disposed for electrical connection to said flexible lead.

In one embodiment said conductive member may form a band around said non-conductive member.

In another embodiment said non-conductive member may be fixed to said support substrate.

In a further embodiment said circuit assembly may comprise one or more additional connection terminals, each of said additional connection terminals being associated with a respective terminal adapter.

In a further embodiment the non-conductive members of a plurality of said terminal adapters may be integral with each other.

In a further embodiment said first connection elements may comprise a metal selected from the group consisting of copper, nickel, palladium, and platinum.

### DESCRIPTION OF THE DRAWINGS

The drawings will illustrate example embodiments of the present invention.

FIG. 1 shows a perspective prior art connection terminal with a wire attached.

FIG. 2 shows a cross-section of the prior art connection terminal shown in FIG. 1, taken along line 2-2.

FIG. 3 shows a perspective view of an example terminal adapter according to the invention.

FIG. 4 shows a cross-section of the example terminal adapter shown in FIG. 3 taken along line 4-4.

FIG. 4a shows a perspective view of another example terminal adapter according to the invention.

FIG. 4b shows a cross-section of the terminal adapter shown in FIG. 4a, taken along line 4b-4b.

FIGS. 5, 6, 7, 8, 9, and 10 show an example method of attaching the terminal adapter shown in FIG. 3 to the prior art connection terminal shown in FIG. 1.

FIG. 10a shows the example circuit assembly shown in FIG. 10, with a wire attached.

FIG. 10b shows the example circuit assembly shown in FIG. 10a, in which the wire connects the circuit assembly to another device.

FIG. 11 shows a prior art circuit assembly.

FIG. 12 shows a circuit assembly fitted with a terminal adapter according to the present invention.

FIG. 13 shows the circuit assembly as shown in FIG. 12 with wires attached.

FIG. 14 shows an example embodiment of a terminal adapter according to the invention, having plated connection elements.

FIG. 15 shows another example embodiment of a terminal adapter according to the invention, also having plated connection elements.

FIG. 16 shows a further example embodiment of a terminal adapter according to the invention, having intermediate connection elements made from a solid metal body.

FIG. 17 shows an example embodiment of a terminal adapter according to the invention, and intermediate connection elements made from a solid metal body, and a connection element disposed on the side thereof.

FIG. 18 shows an example embodiment of a terminal adapter according to the invention, the terminal adapter being designed for a ball array grid connection.

FIG. 19 shows a perspective view of a substrate having connection terminals disposed on its edge.

FIG. 20 shows a perspective view of a substrate as shown in FIG. 19, provided with a terminal adapter according to one example embodiment of the invention.

### DETAILED DESCRIPTION

FIG. 1 shows a perspective view of a corner of a support substrate 20 used with a circuit assembly according to one example embodiment of the invention. The substrate 20 is used to make a circuit assembly. As can be seen the substrate 20 has been provided with a connection terminal 30.

It is common for substrates used with circuit assemblies to be composed of one or more non-conductive layers, which have conductive traces (i.e. leads equivalent to wires) sandwiched between them as well as disposed on their surfaces.

As can be seen in FIG. 2, substrate 20 has only one non-conductive layer 22 in which connection terminal 30 is disposed. The non-conductive layer 22 may be for example made of a ceramic material, such as a 96% aluminum oxide ceramic material. Other ceramic materials may include aluminum nitraide, and silicon carbide.

A ceramic material may be used to make the non-conductive layers because ceramic is a very stable, rigid, non-hygroscopic material that can easily be provided with conductor traces. Ceramic substrates can also accommodate integrated circuits in die form and many other types of active and passive components.

It should be noted that although ceramic is generally used to make substrates for the circuit assemblies, other non-conductive materials might be used. For instance, glass-epoxy or flexible polyamide substrates may also be used. One such flexible polyamide substrate is available under the trademark Kapton.

Turning back to FIG. 1 we can see that the connection terminal 30 is disposed on the surface of the substrate 20. Also disposed on the surface of substrate 20 is conductor trace 32, which connects connection terminal 30 with the rest of the circuit assembly (not shown).

The material used to make connection terminal 30 and the conductor trace 32 usually depends on the method used to form the connection terminal 30 and the conductor trace 32 on the substrate. The method used further depends on the material the substrate 20 is made from.

In the case of a ceramic substrate there are two main methods of forming the connection terminal 30 and the conductor trace 32. These methods are the thick film method and the thin film method.

In the thick film method the conductor trace 32 and the connection terminal 30 are formed from a metallic paste, which is screen-printed onto the substrate 20. The metallic paste is a combination of metal powder, glass frit, and an organic binding agent (e.g. pine oil). This metallic paste is then deposited on the substrate 20 in a predetermined pattern that is the pattern of the circuit assembly. The substrate is then dried, and after wards fired at 850 degrees C. As the substrate is fired the glass frit melts and provides adhesion between the metal powder and the substrate 20. During the firing process the metal powder forms continuous conductor traces 32 and connection terminals 30 in the substrate 20.

The thick film method commonly uses Palladium Silver (PdAg), which provides good leach resistance and good adhesion, or Copper or Platinum Gold (PtAu) which have excellent leach resistance, but lower adhesion. Other materials used are Platinum Silver (PtAg), Platinum Palladium Silver (PtPdAg), and Platinum Palladium Silver (PtPdAu). The metal or alloy used is selected based on leach resistance and adhesion.

In the thin film method conductors are deposited onto the substrate by sputtering a target metal in a vacuum chamber. The deposited metal is then patterned using an etching process, which defines the conductor patterns.

The thin film method uses a variety of alloys, with base metals including Titanium, Nickel-Chrome, or Chromium-Copper. The base metals are also provided with a top layer of gold.

Of these two methods the thick film method is most commonly used since it is less expensive and can be more versatile, though the thin film method can give finer lines and spaces than thick film and has better characteristics at higher frequencies.

In the case that the substrate 20 is made from glass-epoxy or a flexible polyamide then the connection terminal 30 and the conductor trace 32 is usually formed by etching off a metal layer that is laminated to the surface of the substrate. This metal layer may be made from copper foil.

After the connection terminal 30 has been formed in the substrate 20, it may be used to connect the circuit assembly together with other circuit assemblies to form a larger device. The connection of the circuit assembly to other circuit assemblies is typically achieved by soldering wires 35 to the connection terminals 30, as may be seen in FIG. 1.

During the process of soldering, the connection terminal 30 is heated to the melting point of a solder, commonly a tin and lead alloy. The solder is then applied to the connection terminal 30 causing the solder to melt and surround the wire 35, which is being soldered to the connection terminal 30. After the solder cools it hardens and forms a bond between the connection terminal 30 and the wire 35.

This process can be problematic. The reason for this is that the heating of the connection terminal 30 may cause the metal of the connection terminal 30 to melt and leach into the solder, thus weakening the connection terminal 30 and in turn the connection of the wire 35 to the substrate 20. If leaching goes on too long then the connection terminal 30 may disappear entirely and the wire 35 will lose all connection to the substrate 20.

While most connection terminals 30 are made such that they can withstand the soldering process a few times, typically 3-4, during normal circumstances, it is still possible to damage the connection terminal 30 if proper care is not taken. For instance if the connection terminal 30 is heated to a temperature greater than what is needed to melt the solder (typically 183 degrees C.), or if it is kept heated for too long a time, then the connection terminal 30 may only withstand the soldering process a single time.

In addition to the problem of leaching prior art connection terminal 30 has the problem that the connection between the wire 35 and the connection terminal 30 may not hold if pulling forces affect the wire 35. These pulling forces may result from movements during the connection of the circuit assembly to another circuit assembly.

The connection of the wire 35 and the connection terminal 30 has two important points which both need to be able to withstand the pulling forces. These points are the attachment of the wire 35 to the connection terminal 30, and the attachment of the connection terminal 30 to the substrate 20. The more critical of these two points is the connection between the connection terminal 30 and the substrate 20. The reason for this is that if the connection terminal 30 becomes detached from the substrate there is little chance of repair, while if the wire 35 become detached from the connection terminal 30, it can usually be reattached.

If the connection terminal 30 is of typical size, that is 0.5 mm×0.5 mm, then it is preferred that the connection between the wire 35 and the connection terminal 30, and the connection terminal 30 and the substrate 20 be able to withstand a pulling force of at least 0.8 lbf (3.56 N). It has been determined that if the connections are able to withstand forces of this magnitude then relatively low amounts of failures will occur.

How much pulling force any give connection terminal 30 is able to withstand is additionally affected by type of metal or metal alloy used to make the connection terminal 30. For instance, some commonly alloys, such as Palladium Silver, are able to withstand pulling forces around 0.5 lbf, while others, such as Platinum Gold and Copper, can only withstand much lower forces.

These numbers will of course vary with differently sized connection terminals.

While it would appear that one would try to use materials that provide good connections to both the wire 35 and the substrate 20, this is not always possible. The main reason for this is that materials with high adhesion usually have low resistance to leaching. Since leaching can cause bad connections by destroying the connection terminal 30, it would be futile to use materials that provide good connections, only to have them be destroyed by leaching.

Thus, it often becomes necessary to compromise and select materials that only provide moderately good connections between the wire 35 and the connection terminal 30, and between the connection terminal 30 and the substrate 20, but that are also moderately resistant to leaching. The result is that often it is not possible to have connections that are able to withstand a pulling force of 0.81 bf, between the wire 35 and the connection terminal 30, and the connection terminal 30 and the substrate 20.

The most common modes of failure due to low strength connections are:

a. the removal of the connection terminal from the substrate along with parts of the substrate,

b. the removal of the connection terminal from the substrate,

c. the removal of the solder from the connection terminal, and

d. the removal of the wire from the solder.

Of these modes of failure d is the most desirable since the wire may be easily reattached to the solder, thus repairing the connection. On the other hand, the least desirable ones are a and b, which are unfixable. Unfortunately, a and b are the most common modes of failure in a substrate that is metallized using the thick film method mentioned above.

Moving on to FIGS. 3 and 4, we can see an example terminal adapter 40 according to one embodiment of the invention. In this example the terminal adapter 40 comprises a non-conductive member 42 with a conductive member 43 extending through it and formed integral therewith. The non-conductive member 42 is made from a non-conductive material, for instance an epoxy resin based printed circuit board material.

The conductive member 43 comprises a first connection element 46 placed on the top, a second connection element 48 placed on the bottom, and an intermediate connection element 44 electrically connecting the first connection element 46 and the second connection element 48. The first and second connection elements 46 and 48 may be formed integral with the intermediate connection element 44. The first and second connection elements 46 and 48 may be made from metals having high resistance to leaching.

Turning to FIGS. 4a and 4b, we can see another example embodiment of a terminal adapter 40a according to the invention. As can be seen the terminal adapter 40a is made from a non-conductive member 42a and a conductive member 43a forming a band around the non-conductive member 42a. The conductive member 43a comprises a first connection element 46a, a second connection element 48a, and two intermediate connection elements 44a. Said first connection element 46a, said second connection element 48a being electrically connected by said intermediate connection elements 44a.

Also, as can be seen in FIG. 4b, the first connection element 46a, the second connection element 48a, and the intermediate connection elements 44a are integral.

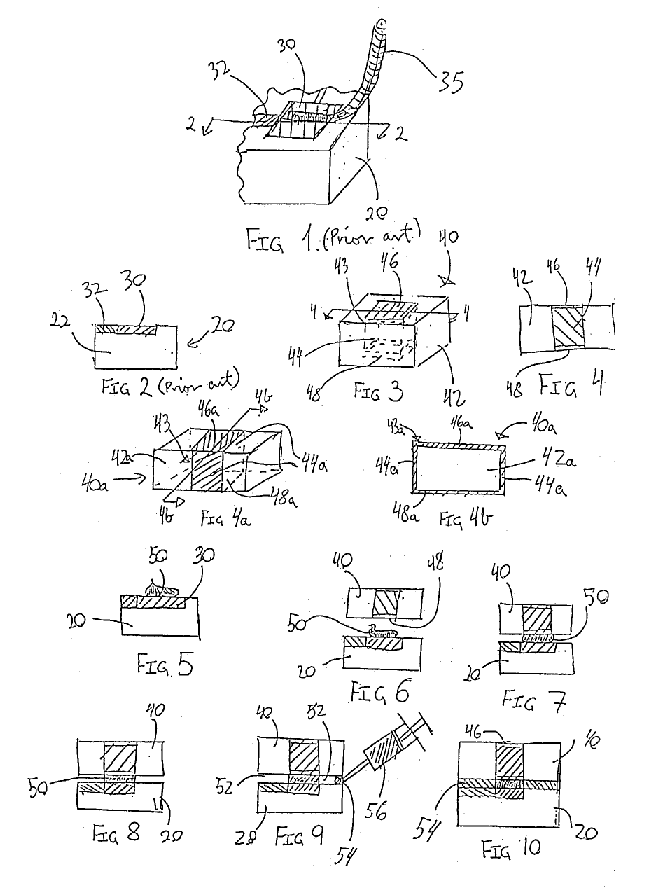

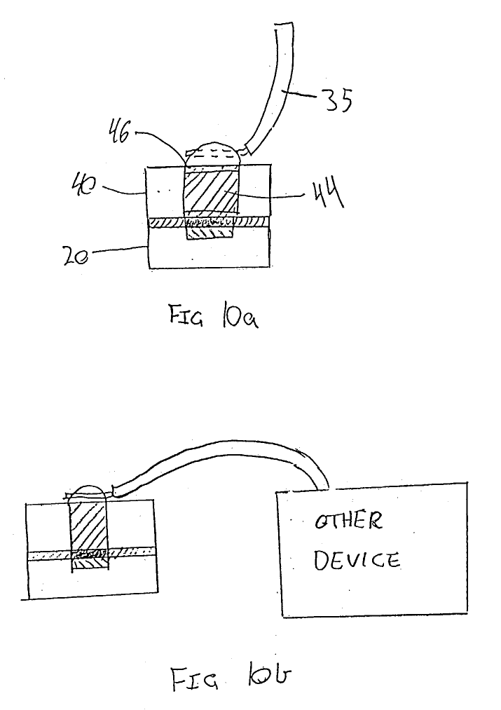

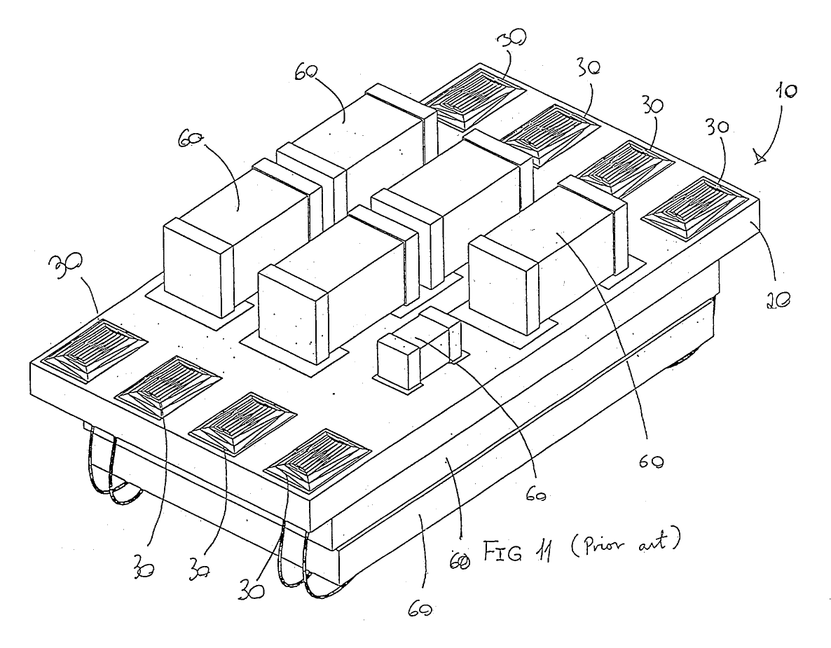

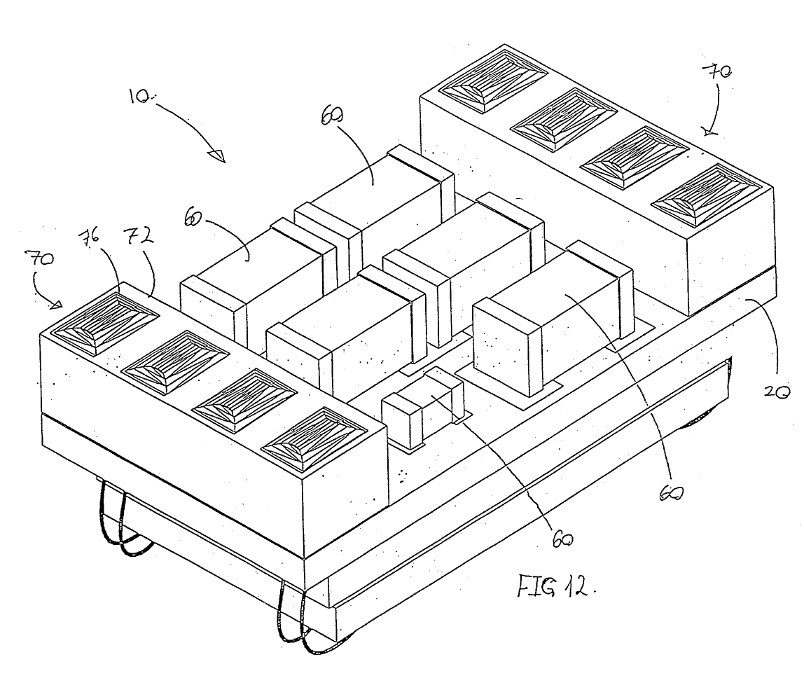

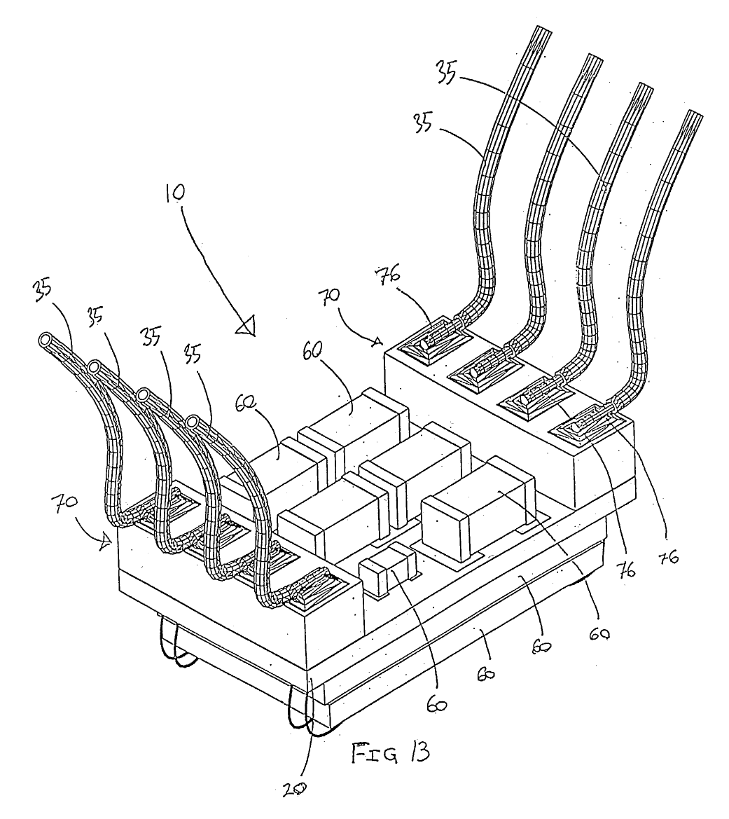

The terminal adapters 40 (see FIG. 3) and 40a (see FIG. 4a) are both designed such that they may be attached to connection terminal 30 (see FIG. 8), and additionally, if so desired to substrate 20 (e.g. see FIG. 10). This attachment serves to provide the circuit assembly with a soldering point which is less susceptible to leaching and favors a better attachment to the wire 35. This soldering point is of course being first connection elements 46, and 46a. In the case of terminal adapter 40a, the wire 35 may also be soldered to either of intermediate connection elements 44a.

Moving on to FIGS. 5 to 10 we can see the process, which is used to attach the terminal adapter 40 to the substrate 20. This process may also just as easily be applied to terminal adapter 40a.

In FIG. 5 we can see the first step, which is to apply a solder paste 50 to the connection terminal 30 on the substrate 20. The solder paste 50 is typically a blend of metal alloy powder and a flux material.

In FIG. 6, we see that the terminal adapter 40 is placed above the substrate, such that second connection element 48 is directly above the connection terminal 30. The terminal adapter is then moved down towards the substrate until second connection element 48 comes in contact with the solder paste (see FIG. 7).

After the second connection element 48 of the terminal adapter 40 is brought into contact with the solder paste 50, the combination of the terminal adapter 40 and the substrate 20 is placed in a re-flow oven (one such oven is described in U.S. Pat. No. 6,446,855 to Rich). In the re-flow oven the terminal adapter 40 and the substrate are allowed to heat until the alloy of the solder paste 50 melts. When the alloy of the solder paste 50 melts the flux material in the solder paste 50 causes the solder paste to spread over the connection terminal 30 and the connection element 48.

The substrate 20 and the terminal adapter 40 are then taken out of the re-flow oven and are allowed to cool. As the solder paste 50 cools it solidifies and forms a mechanical and electrical connection between the connection terminal 30 and the connection element 48 (see FIG. 8), thus completing the attachment of the terminal adapter 40 to the substrate 20.

It should be noted that the re-flowing process is strictly controlled such that it does not become too hot, thereby causing the connection terminal 30 to leach into the solder paste 50. Also the re-flow process is fairly short, lasting only about 10-15 seconds, so that the components do not become damaged.

After allowing the solder paste 50 to cool, there usually remain some small spaces 52 between the terminal adapter 40 and the substrate 20. As seen in FIG. 9, these spaces 52 may be, if desired, injected with a non-conductive epoxy 54 so as to strengthen the connection between the substrate and terminal adapter 40. The non-conductive epoxy 54 may be injected using a syringe 56. After the non-conductive epoxy 54 has been injected, is cured, thus forming a bond between the substrate and the terminal adapter 40. A finished assembly, which has been injected with non-conductive epoxy, may be seen in FIG. 10.

It should be noted that while the process for attaching the terminal adapter 40 to the substrate 20 was described using solder paste 50, the process can just as easily be accomplished using another material, such as for instance a conductive epoxy.

FIG. 10a shows the assembly shown in FIG. 10 with a wire 35 soldered to first connection element 46 on the top of the terminal adapter 40. This solder connection is much less susceptible to leaching and favors a stronger adhesion of the wire 35 to the circuit assembly. The main reason for this is the inclusion of the terminal adapter 40. FIG. 10b shows the assembly of FIG. 10a wherein the wire is attached to an other device (e.g. a camera in endoscope, a microphone, volume control, or a receiver (speaker) in a hearing aid).

Since the wire 35 is soldered to the first connection element 46 rather than to the connection terminal 30, the first connection element 46 will be heated during the soldering process. As stated above, the first connection element 46 may be made from a material that is less susceptible to leaching at the temperatures of the soldering process as well as above-normal temperatures.

The connection between the wire 35 and the first connection element 46 will also favor stronger adhesion. The reason for this is that the first connection element 46 is integral with intermediate connection element 44. Also the connection between the connection terminal 30 and the substrate 20 may be augmented by the connection between the substrate 20 and the non-conductive member 42 of the terminal adapter 40.

Thus, a weak link in the chain of connections between wire 35 and the circuit assembly may be the solder connection between the wire 35 and the first connection element 46. Therefore, if the connection between the wire 35 and the circuit assembly does break such breakage will lean toward the detachment of the wire 35 from the first connection element 46. This failure being the most desirable since the wire 35 may be easily reattached by soldering.

FIG. 11 shows a prior art circuit assembly 10. The circuit assembly 10 comprises substrate 20, fitted with one or more connection terminals 30, and a plurality of electrically interconnected electronic components 60. The connection terminals 30 have also been provided with solder so that the circuit assembly. 10 may easily be connected to other components.

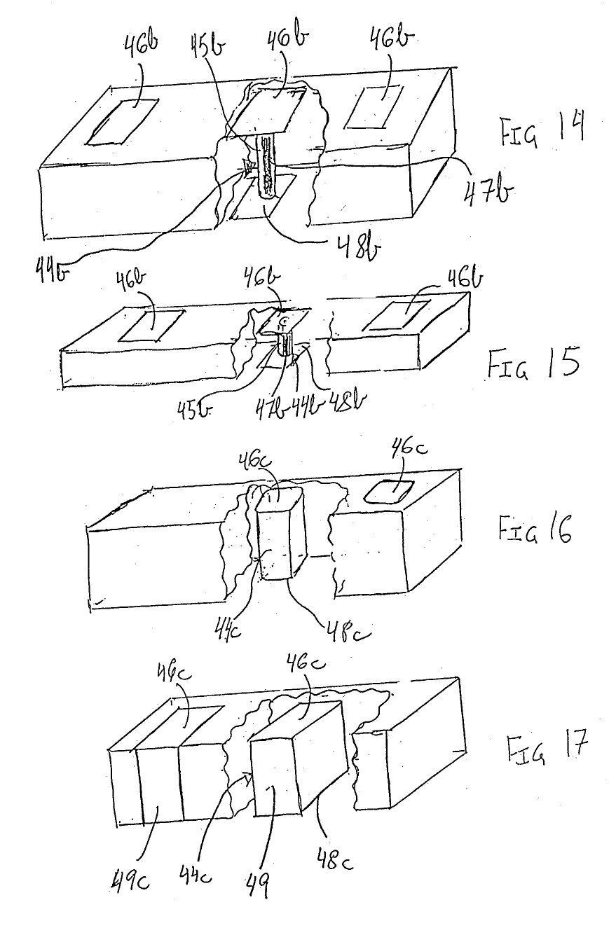

Moving on to FIG. 12 we see circuit assembly 10 having been fitted with terminal adapter 70 according to an example embodiment of the invention. As can be seen the terminal adapter 70 is slightly different than the terminal adapter 40. The main difference lies in that terminal adapter 70 has been designed to connect to multiple connection terminals 30, rather that just one.

The principle of the terminal adapters 40 and 70 is the same; only terminal adapter 70 has a longer non-conductive body 72 into which multiple intermediate connection elements (not shown) identical to intermediate connection element 44 have been formed. The same effect could have been accomplished by placing several terminal adapters 40 beside one another.

Additionally, first connection elements 76 of terminal adapter 70 have been provided with solder so that the circuit assembly 10 may easily be connected to other components.

Turning to FIG. 13, we can see that wires 35 may be connected to the circuit assembly 10 by soldering them to the connection elements 76 of the terminal adapter 70. The connection elements 70 may, for example, be made of a highly leach resistant material. In such case since the soldering is performed on the connection elements 76, the chance of leaching occurring may be obviated.

Additionally, since the first connection elements 76 are attached to, and often formed integral with, the intermediate connection elements of the terminal adapter 70 there is a relatively smaller possibility that pulling forces on the wires 35 will cause the connection elements 76 to become detached from the terminal adapters 70.

In fact, as mentioned with respect to terminal adapter 40 the construction of the terminal adapter 70 favors that if the wires 35 become detached from the circuit assembly 10 due to pulling forces acting on the wires 35, then this detachment occurs due to the wires 35 being pulled out of the solder on the connection elements 76. This failure modes being the most desirable since the wires 35 may be easily reattached.

As can be seen from the different variations of the terminal adapter seen in FIG. 3 and FIG. 12, the shape and form of the terminal adapter is quite mutable. For instance, as shown in FIG. 3, a terminal adapter 40 may be designed to attach to only a single connection terminal 30. In this case the body 42 of the terminal adapter 40 would only have a single intermediate connection element 44 and a single set of first and second connection elements 46 and 48.

On the other hand a terminal adapter may be designed to attach to multiple connection terminals 30, such as terminal adapter 70 shown in FIG. 12. In the case of terminal adapter 70 the body 72 is extended to allow for multiple intermediate connection elements and multiple pairs of first connection elements 76 and second connection elements (not shown).

The main concerns, which govern the selection of a particular design of terminal adapter lie with convenience in creating the circuit assembly to which it will be attached. For instance, in relation to circuit assembly 10, multiple terminal adapters 40 (see FIG. 3) might have been used instead of a single terminal adapter 70. However, from a manufacturing perspective terminal adapter 70 is much simple to attach since it is a single component rather that four different components.

Moving on to FIGS. 14, 15, 16, 17, and 18, we can see several other example embodiments of terminal adapters according to the present invention.

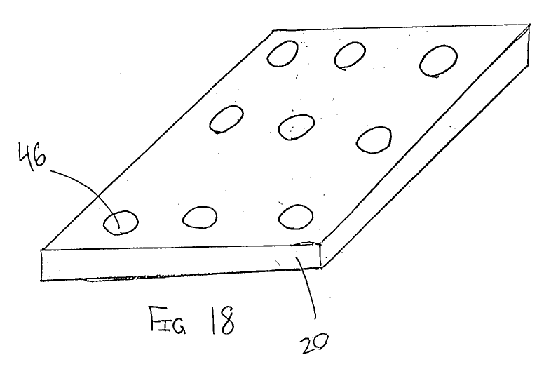

For instance in FIGS. 14 and 15, terminal adapters with metal plated connection elements 46b and 48b may be seen. Furthermore, the intermediate connection elements 44b are made of metal plating 45b filled with a conductive epoxy 47b. To strengthen the bond between the metal plated of the connection elements 46b and 48b may be formed integral with the metal plating 45b of the intermediate connection elements. In this example embodiment, copper is often used as the metal in the connection elements 46 and 48b, as well as the metal plating 45b. The reason is used is that copper is a metal that does not leach into the solder. It is of course to be understood that any other leach resistant metal may be used.

Also, as may be seen, the terminal adapter may be adjusted in height to accommodate circuit assemblies. For instance, the thinner terminal adapter shown in FIG. 15 may be used with a circuit assembly, which will be attached to other circuits using only wires. The thicker terminal adapter shown in FIG. 16, on the other hand allows for the connection terminals 30 to be directly connected to other circuits, as well as the encapsulation of the components 60 in an encapsulant.

While the terminal adapter may be made quite thin it is preferred that it have a thickness of at least 5 mils (127 um).

FIG. 16, shows another example embodiment. In this embodiment the connection elements 46c and 48c are formed integral with the intermediate connection elements 44c. The intermediate connection elements 44c are made from a single metal body. This terminal adapter may be used since it is easier to manufacture than, for instance the terminal adapter shown in FIG. 14.

FIG. 17, shows another example embodiment. In this embodiment, a third connection element 49d has been added to the side of the terminal adapter. This third connection element 49d allows for additional wires to be attached to the terminal adapter. As with the terminal adapter shown in FIG. 16, this example embodiment also uses solid metal bodies for the intermediate connection elements 44c, with the connection elements 46c, 48c, and 49 just being different sides of the solid metal bodies.

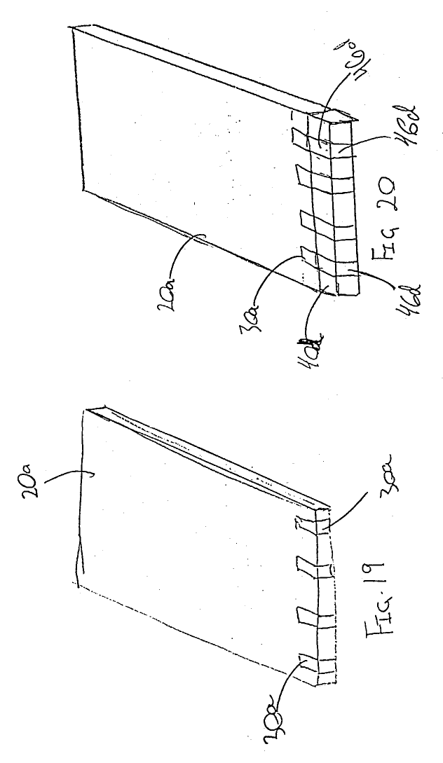

Finally, FIG. 18 shows a terminal adapter designed for a circuit assembly, which is to be connected to other components using a ball grid array. In this instance the intermediate connection elements 44 and the connection elements 46b and 48b use the same design that as shown in FIGS. 14 and 15.

While the preceding terminal adapter have been shown in relation to substrates with connection terminals on the top surface, it should be noted that the terminal adapters might be used with other types of substrates.

For instance, FIG. 19 shows a substrate 20a in which the connection terminals 30a are disposed on the edge of the substrate 20a, rather than the top of the substrate. This type of substrate may also be fitted with a terminal adapter to provide leach resistance and better adhesion.

FIG. 20 shows the substrate 20a shown in FIG. 19 with a terminal adapter 40d attached. As with the top mounted terminal adapters shown previously, the terminal adapter 40d has connection elements 46d, which are electrically connected to the connection terminals 30a. As with the previously described terminal adapters the terminal adapter 40d is attached to the substrate 20a by a combination of solder or conductive epoxy, and a non-conductive epoxy.

1. A method for the manufacture of a circuit assembly connected to a flexible lead for connecting to an other device, said circuit assembly comprising a circuit associated with a respective support substrate and a connection terminal disposed on said substrate for electrically connecting said circuit to an other device by said flexible lead, said method comprising:
attaching to at least one of said circuit assemblies a terminal adapter comprising a conductive member,
said conductive member comprising a first connection element, a second connection element, and an intermediate connection element, said intermediate connection element electrically connecting said first connection element to said second connection element,
said terminal adapter being disposed such that
said second connection element is fixed and electrically connected to said connection terminal, and
said first connection element is disposed for electrical connection to said flexible lead.

2. A method for the manufacture of a circuit assembly connected to a flexible lead for connecting to an other device, said circuit assembly comprising a circuit associated with a respective support substrate and a connection terminal disposed on said substrate for electrically connecting said circuit to an other device by said flexible lead, said method comprising:
attaching to at least one of said circuit assemblies a terminal adapter comprising a conductive member and a non-conductive member,
said conductive member comprising a first connection element, a second connection element, and an intermediate connection element, said intermediate connection element electrically connecting said first connection element to said second connection element,
said non-conductive member extending from said first connection element to a second connection element
said terminal adapter being disposed such that
said second connection element is fixed and electrically connected to said connection terminal, and
said first connection element is disposed for electrical connection to said flexible lead.

3. A circuit assembly comprising:
a circuit associated with a support substrate; and
a connection terminal disposed on said support substrate for electrically connecting said circuit assembly to an other device;
characterized in that said circuit assembly comprises a terminal adapter,
said terminal adapter comprising a conductive member,
said conductive member comprising a first connection element, a second connection element, and an intermediate connection element, said intermediate connection element electrically connecting said first connection element to said second connection element,
said terminal adapter being disposed such that
said second connection element is fixed and electrically connected to said connection terminal, and
said first connection element is disposed for electrical connection to said other device.

4. A circuit assembly comprising:
a circuit associated with a support substrate; and
a connection terminal disposed on said support substrate for electrically connecting said circuit assembly to an other device;
characterized in that said circuit assembly comprises a terminal adapter
said terminal adapter comprising a conductive member and a non-conductive member;
said conductive member comprising a first connection element, a second connection element, and an intermediate connection element, said intermediate connection element electrically connecting said first connection element to said second connection element;
said non-conductive member extending from said first connection element to a second connection element;
said terminal adapter being disposed such that
said second connection element is fixed and electrically connected to said connection terminal, and
said first connection element is disposed for electrical connection to said other device.

5. A circuit assembly comprising:
a plurality of circuits each associated with a corresponding support substrate; and
a plurality connection terminal disposed on said support substrates for electrically connecting said circuits to each other by a flexible lead;
characterized in that at least one said circuits comprises a terminal adapter,
said terminal adapter comprising a conductive member and a non-conductive member;
said conductive member comprising a first connection element, a second connection element, and an intermediate connection element, said intermediate connection element electrically connecting said first connection element to said second connection element;
said non-conductive member extending from said first connection element to a second connection element;
said terminal adapter being disposed such that
said second connection element is fixed and electrically connected to said connection terminal, and
said first connection element is disposed for electrical connection to said flexible lead.

6. A circuit assembly as described in claim 4, wherein said conductive member forms a band around said non-conductive member.

7. A circuit assembly as described in claim 4, 5, or 6, wherein said non-conductive member is fixed to said support substrate.

8. A circuit assembly as described in claim 3 comprising one or more additional connection terminals, each of said additional connection terminals being associated with a respective terminal adapter.

9. A circuit assembly as described in claim 4,5, 6, or 7 comprising one or more additional connection terminals, each of said additional connection terminals being associated with a respective terminal adapter.

10. A circuit assembly as described in claim 9, wherein the non-conductive members of a plurality of said terminal adapters are integral with each other.

11. A circuit assembly as described in claim 8, 9, or 10 wherein said first connection elements comprises a metal selected from the group consisting of copper, palladium, platinum.

12. A method for the manufacture of a circuit assembly connected to a flexible lead for connecting to an other device, said circuit assembly comprising a circuit associated with a respective support substrate and a connection terminal disposed on said substrate for electrically connecting said circuit to an other device by said flexible lead, said method being characterized in that said circuit assembly comprises a terminal adapter
wherein said terminal adapter comprises a conductive member,
said conductive member comprising a first connection element, a second connection element, and an intermediate connection element, said intermediate connection element electrically connecting said first connection element to said second connection element,
said terminal adapter being disposed such that
said second connection element is fixed and electrically connected to said connection terminal, and
said first connection element is disposed for electrical connection to said flexible lead
and wherein said method comprises soldering said flexible lead to said first connection element such that said flexible lead is fixed and electrically connected to said first connection element.

13. A circuit assembly comprising:
a circuit associated with a support substrate;
a flexible lead for electrically connecting the circuit to an other device; and
a connection terminal disposed on said support substrate for electrically connecting said circuit to said flexible lead;
characterized in that said circuit assembly comprises a terminal adapter,
said terminal adapter comprising a conductive member,
said conductive member comprising a first connection element, a second connection element, and an intermediate connection element, said intermediate connection element electrically connecting said first connection element to said second connection element,
said terminal adapter being disposed such that
said second connection element is fixed and electrically connected to said connection terminal, and
said first connection element is soldered to said flexible lead such that said flexible lead is fixed and electrically connected to said first connection element for electrical connection to said other device.

14. A method for the manufacture of a circuit assembly connected to a flexible lead for connecting to an other device, said circuit assembly comprising a circuit associated with a respective support substrate and a connection terminal disposed on said substrate for electrically connecting said circuit to an other device by said flexible lead,
said method being characterized in that said circuit assembly comprises a terminal adapter
wherein said terminal adapter comprises a conductive member and a non-conductive member,
said conductive member comprising a first connection element, a second connection element, and an intermediate connection element, said intermediate connection element electrically connecting said first connection element to said second connection element,
said non-conductive member extending from said first connection element to a second connection element
said terminal adapter being disposed such that
said second connection element is fixed and electrically connected to said connection terminal, and
said first connection element is disposed for electrical connection to said flexible lead
and wherein said method comprises soldering said flexible lead to said first connection element such that said flexible lead is fixed and electrically connected to said first connection element.

15. A circuit assembly comprising:
a circuit associated with a support substrate
a flexible lead for electrically connecting the circuit to an other device; and
a connection terminal disposed on said support substrate for electrically connecting said circuit to said flexible lead;
characterized in that said circuit assembly comprises a terminal adapter,
said terminal adapter comprising a conductive member and a non-conductive member, said conductive member comprising a first connection element, a second connection element, and an intermediate connection element, said intermediate connection element electrically connecting said first connection element to said second connection element,
said non-conductive member extending from said first connection element to a second connection element
said terminal adapter being disposed such that
said second connection element is fixed and electrically connected to said connection terminal, and
said first connection element is soldered to said flexible lead such that said flexible lead is fixed and electrically connected to said first connection element for electrical connection to said other device.
